(19) United States
(12) Patent Application Publication
(10) Pub. No.: US 2019/0102991 A1
(43) Pub. Date: Apr. 4, 2019

(54) INFORMATION PROCESSOR AND GAME CONTROL METHOD

(71) Applicant: Universal Entertainment Corporation, Tokyo (JP)

(72) Inventors: Masaki OYAMA, Tokyo (JP); Atsushi KUMITA, Tokyo (JP); Toshikazu JINNOUCHI, Tokyo (JP)

(21) Appl. No.: 16/143,686

(22) Filed: Sep. 27, 2018

(30) Foreign Application Priority Data
Sep. 29, 2017 (JP) 2017-191610

(51) Int. Cl. G07F 17/32

(52) U.S. Cl. CPC G07F 17/3255; G07F 17/3288; G07F 17/3211

(57) ABSTRACT

The present invention provides an information processor and a game control method for urging a game player to pay. The information processor 1 of the present invention comprises: an input device 5 that performs an operation related to a game, a display 2 for displaying a game screen based on the operation of the input device 5, and a controller 10 that gives a predetermined benefit after the game screen is displayed on the display 2, wherein the controller 10 further performs the following processes: a process of displaying an icon 11 prompting transition to a payment screen for paying on the display 2 after the game screen is displayed, a process of transitioning to the payment screen when the icon 11 is selected by the input device 5, and a process of increasing the predetermined benefit when paying on the payment screen.

### CROSS-REFERENCE TO RELATED APPLICATION

This Application is Entitled to the benefit of Japanese Pat. App. No. 2017-191610, filed on Sep. 29, 2017.

### BACKGROUND OF THE INVENTION

### 1. Field of Invention

The present invention relates to an information processor and a game control method.

### 2. Description of Related Art

Patent Document 1 (US Patent Application Publication No. 2013/252742) describes a server system in which a random determination icon for starting a random determination that can be executed once at the time of login is displayed and when the random determination icon is touched, random determination of items usable in the game becomes possible.

### BRIEF SUMMARY OF THE INVENTION

However, in the server system described in Patent Document 1, items are given to the game player according to a random determination result that can be executed at the time of login, so it is not possible to urge the game player to pay for the item through purchase of items.

Accordingly, an object of the present invention is to provide an information processor and a game control method for urging a game player to pay.

The information processor of the present invention comprises:
the information processor of the present invention comprises:
an input device that performs an operation related to a game,
a display for displaying a game screen based on the operation of the input device, and
a controller that gives a predetermined benefit after the game screen is displayed on the display, the controller executing:
a process of displaying an icon prompting transition to a payment screen for paying on the display after the game screen is displayed,
a process of transitioning to the payment screen when the icon is selected by the input device, and
a process of increasing the predetermined benefit when paying on the payment screen.

According to the above configuration, when the icon is selected by the input device, the screen transitions to the payment screen, and when paying on the payment screen, the predetermined benefit given after the game screen is displayed increases. Therefore, it is possible to urge the game player to pay.

In the information processor of the present invention, authentication information for each game player is stored in a storage device connected to the controller, and in association with the authentication information, the possessed number of the items that can be purchased via a shop screen as the payment screen is stored, and the possessed number of the items stored in association with the authentication information of the game player is displayed simultaneously with the display of the icon popped up after the game screen is displayed.

According to the above configuration, it is possible to easily guide the shop screen through the icon while allowing the game player to recognize the possessed number of the items currently possessed.

In the information processor of the present invention,
the game screen is displayed after logging in to the input device,
the predetermined benefit is a login bonus given with the logging,
the login bonus increases when paying on the shop screen as the payment screen.

According to the above configuration, since the login bonus increases, it is possible to urge the game player to pay for purchasing the items on the shop screen.

A non-temporary recording medium stores a game program of the information processor of the present invention,
the information processor comprising:
an input device that performs an operation related to a game,
a display for displaying a game screen based on the operation of the input device, and
a controller that gives a predetermined benefit after the game screen is displayed on the display, the controller executing:
a process of displaying an icon prompting transition to a payment screen for paying on the display after the game screen is displayed,
a process of transitioning to the payment screen when the icon is selected by the input device, and
a process of increasing the predetermined benefit when paying on the payment screen.

According to the above configuration, when the icon is selected by the input device, the screen transitions to the payment screen, and when paying on the payment screen, the predetermined benefit given after the game screen is displayed increases. Therefore, it is possible to urge the game player to pay.

The game control method of the information processor of the present invention is arranged such that,
the information processor comprises:
an input device that performs an operation related to a game,
a display for displaying a game screen based on the operation of the input device, and
a controller that gives a predetermined benefit after the game screen is displayed on the display, the method comprises the steps of:
displaying an icon prompting transition to a payment screen for paying on the display after the game screen is displayed,
transitioning to the payment screen when the icon is selected by the input device, and
increasing the predetermined benefit when paying on the payment screen.

According to the above configuration, when the icon is selected by the input device, the screen transitions to the payment screen, and when paying on the payment screen, the predetermined benefit given after the game screen is displayed increases. Therefore, it is possible to urge the game player to pay.

The present invention is possible to urge the game player to pay.

### BRIEF DESCRIPTION OF THE DRAWINGS

FIG. 1 is an illustrative view showing an schematic configuration of an information processor.

FIG. 2 is a view showing a screen display of a display, wherein FIG. 2A is a view showing a menu screen, FIG. 2B is a view showing a login bonus display screen, FIG. 2C is a view showing a login bonus acquisition screen, and FIG. 2D is a view showing a shop screen.

FIG. 3 is a view showing a reward given with the login bonus.

FIG. 4 is a block diagram showing an electric configuration of an information processor.

FIG. 5 is an illustrative view showing a display state of the information processor.

FIG. 6 is a functional block diagram of the information processor.

FIG. 7 is an illustrative view showing a game content.

FIG. 8 is a flowchart showing a login process.

FIG. 9 is a flowchart of a slot game process.

FIG. 10 is a flowchart of a bonus game process.

FIG. 11 is a flowchart of a random determination game process.

### DETAILED DESCRIPTION OF THE PREFERRED EMBODIMENT

The information processor of the present invention will be described based on the drawings.

(Information Processor: Overview)

The information processor 1, which is a computer, guides the game player to the shop screen and urges the player to pay for purchasing items. In addition, for example, although it is possible to play a slot game described later using the information processor 1 of the present embodiment, it is not limited thereto. In addition to the slot game, the information processor 1 may be used to play various games such as shooting games, action games, adventure games, role playing games, puzzle games, racing games, simulation games and the like.

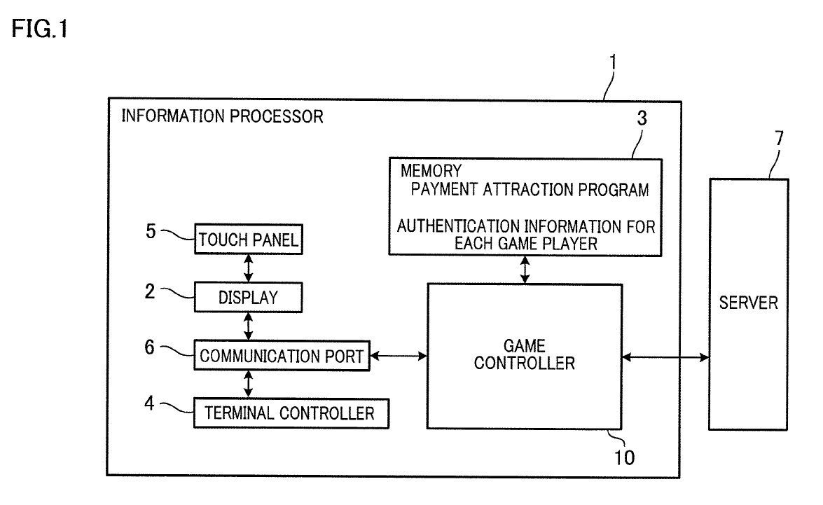

As shown in FIG. 1, the information processor 1 includes a touch panel 5 which is an input device, a display 2, a communication port 6, a game controller (controller of the present invention) 10, and a memory (storage device) 3. The information processor 1 may be portable or stand-by. Examples of the portable information processor 1 include portable information devices such as a portable computer, a laptop computer, a notebook computer, a tablet personal computer, a handheld personal computer, a PDA (Personal Data Assistant), and a smart phone. As the stationary information processor 1, a desktop personal computer and a game machine are exemplified.

Further, the information processor 1 has a terminal controller 4. Details of the terminal controller 4 will be described later. In addition, in the present embodiment, a case will be described, in which the information processor 1 includes the terminal controller 4 and the game controller 10, and the two controllers 4 and 10 cooperatively perform processes. However, the present invention is not limited thereto, and all processes may be performed by the game controller 10.

The touch panel 5 is an input device that performs operations related to games. The touch panel 5 is provided on the entire surface of the display 2 and accepts input from the game player. The touch panel 5 accepts, for example, a login operation to the game by the game player and an item selection operation by the game player on a shop screen which will be described later.

In the following description, when it is stated that a certain object (for example, a game icon 12 to be described later) has been selected by the game player, it means that the game controller 10 determines to select a certain object for the operation of the game player accepted by the touch panel 5.

In addition, in the present embodiment, the touch panel 5 functions as an input device, receives a swipe input and a touch input, and the like, but it is not limited thereto. For example, as an input device, it may be a microphone, a camera, or the like, which may receive voice and gesture of the game player as an instruction operation.

The display 2 displays a game screen based on an operation of the touch panel 5. As a display method of the display 2, various display methods such as a liquid crystal method, an organic electroluminescence method, a CRT (Cathode Ray Tube) method, a plasma method and the like are exemplified.

The communication port 6 is connected to the game controller 10 and exchanges data with the game controller 10. The communication port 6 is a transmission path that can bidirectionally communicate with the Internet, a cable television or the like.

The terminal controller 4 is connected to the touch panel 5, the display 2, and the communication port 6, and controls at least a part of the game. The terminal controller 4 is communicably connected to the server 7 via the communication port 6. As the progress of the game, the server 7 causes the terminal controller 4 to download one-turn of the game program and executes it by the terminal controller 4. However, the present invention is not limited thereto, and the progress of the game may be executed by constantly communicating between the server 7 and the terminal controller 4.

The game controller 10 controls the game displayed on the display 2 in cooperation with the terminal controller 4 while executing transmission and reception of game data through the communication port 6. After the game screen is displayed on the display 2, the game controller 10 gives a predetermined benefit to the game player.

The memory 3 is connected to the game controller 10. The memory 3 stores a program to be executed by the game controller 10. The data and program stored in the memory 3 may be stored in advance at the factory shipment stage or may be downloaded and stored by the communication means from the server 7 or the like.

In the memory 3 of the present embodiment, a payment attraction program for popping up a payment image icon 11 prompting a payment prepared in advance onto the display 2 at appropriate timing is stored. In the present embodiment, the appropriate timing refers to the timing at which the game player logs in to the game and the game screen is displayed on the display 2, but this timing is not limited thereto. The payment image icon 11 is an icon for promoting transition to the payment screen (shop screen) for paying after the game screen is displayed by logging in to the game. In addition, the memory 3 stores authentication information for each game player, and the possessed number of the items that can be purchased via the shop screen in association with this authentication information is stored.

The game controller 10 performs the following processes in accordance with the game program stored in the memory 3. That is, the game program and the game control method of the information processor 1 cause the following processes to be executed. In other words, the game program stored in the memory 3 causes the information processor 1 to execute the following processes. Specifically, the game controller 10 performs a process (A1) of displaying the icon 11 prompting transition to the shop screen for paying on the display 2 after the game screen is displayed, a process (A2) of transitioning to the shop screen when the icon 11 is selected by the touch panel 5, and a process (A3) of increasing the login bonus when paying on the shop screen.

The server 7 that causes the information processor 1 to execute a game is connected to the game controller 10. The connection between the game controller 10 and the server 7 may be either wired or wireless.

(Information Processor: Screen Display of Display)

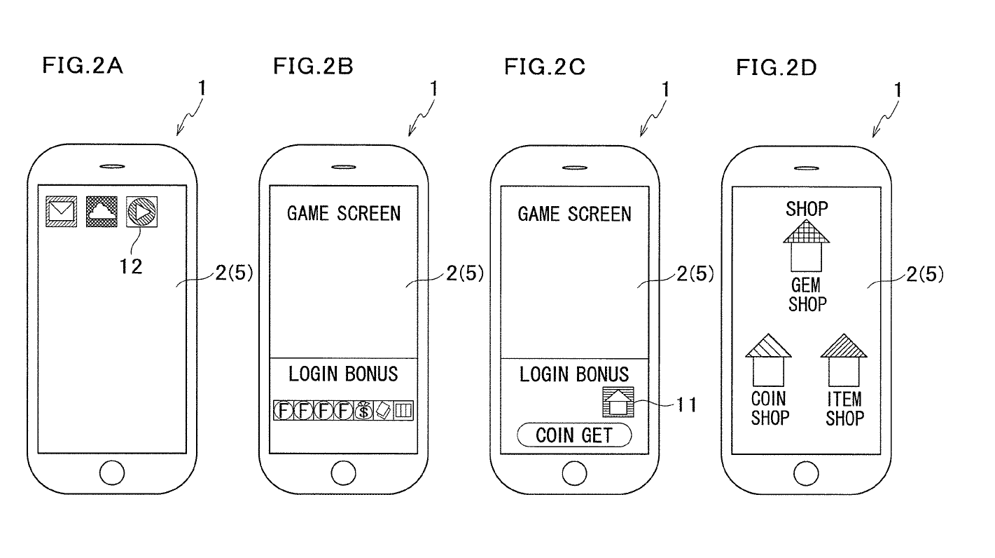

The display 2 displays a menu screen (see FIG. 2A) where a game icon 12 for logging in to the game is arranged, a login bonus display screen (see FIG. 2B) displaying the reward of the login bonus to be given to the game player at the time of logging in to the game, a login bonus acquisition screen (see FIG. 2C) displayed at the timing when the game player acquires the reward, and a shop screen (payment screen) (see FIG. 2D) on which the game player can purchase the items by paying.

The login bonus is a stamp login bonus that can be selected once a day at the first login. In the login bonus, items or coins corresponding to the squares of seven days partitioned on the sheet are given to the game player. In the login bonus display screen, items or icons of coin are drawn in the square (see FIG. 2B), so that the game player can acquire items or coins for one square once a day. Finish marks “F” are stamped on the squares that have acquired these rewards, and when the game player gets the login bonus for seven days, it switches to a new sheet. Three kinds of sheets of bronze sheet, silver sheet and gold sheet are switched in this order. After the gold sheet is used, it returns to the bronze sheet.

In addition, the game player can purchase a login bonus sheet dedicated to paying at the timing when the sheet is switched. There are two types of login bonus sheets dedicated to paying: a platinum sheet and a diamond sheet with a higher price than the platinum sheet. The game player can purchase only the platinum sheet, but if purchasing both the platinum sheet and the diamond sheet, the sheets will be switched in order of bronze sheet, silver sheet, gold sheet, platinum sheet and diamond sheet.

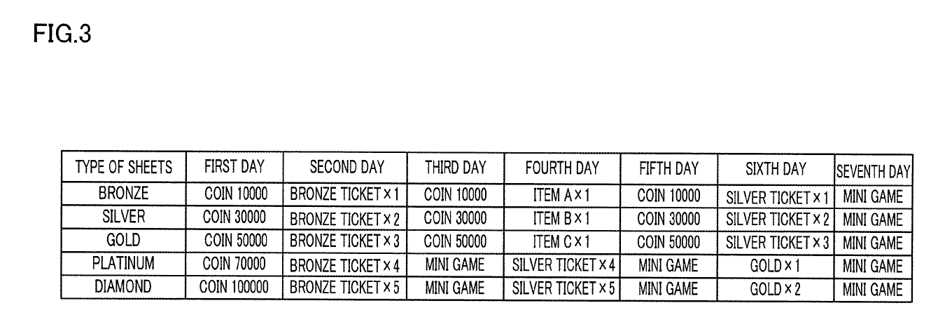

For example, the rewards that the game player can acquire in the login bonus include coins, tickets, items, and the like (see FIG. 3). When the game player acquires the login bonus, a login bonus acquisition screen is displayed on the display 2 (see FIG. 2C).

On the shop screen shown in FIG. 2D, three types of shops are displayed: a gem shop, a coin shop and an item shop. The game player can arbitrarily visit each shop by operating the touch panel 5. In the gem shop, the gems to be used when purchasing coins can be purchased. In the coin shop, the coins necessary for playing video slots and the like can be purchased. In the item shop, items can be purchased with the gems.

There are three types of items: a probability up item, a high speed spin and a full skip. When the probability up item is used, the appearance rate of the bonus game symbol and the three spin symbol increases. When the high speed spin is used, the speed of spin rises. When the full skip is used, spinning by cutting the bonus and other effect. These items have an expiration date.

The rewards that can be acquired by the login bonus and the items that can be purchased on the shop screen are used by the game player when playing the slot game using the information processor 1. Therefore, when playing a game other than the slot game using the information processor 1 of the present embodiment, the reward and an item corresponding to the game to be played are presented to the game player.

(Information Processor 1: Specific Example)

An example of the information processor 1 will be specifically described. In addition, in the following description, a configuration is described in which a slot game for obtaining a game result based on the symbols when the symbols of the video reel are variably displayed and stopped is executed, but the present invention is not limited thereto. In addition, in the following description, the information processor 1 will be described, but the processes and actions of the information processor 1 can be replaced with the invention of the program or the game control method.

(Information Processor 1: Specific Example: Electric Configuration)

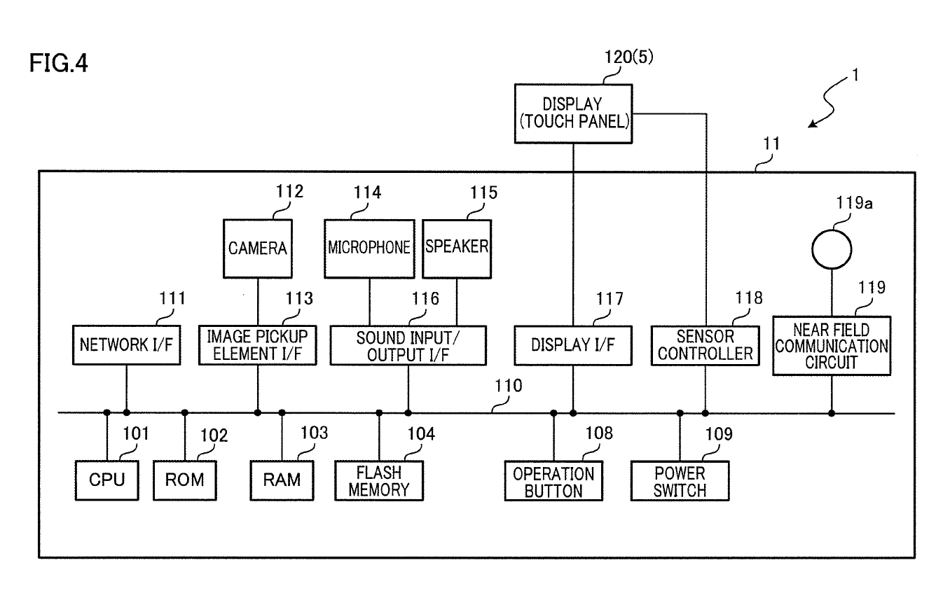

As shown in FIG. 4, the information processor 1 includes a CPU 101, a ROM 102, a RAM 103, a flash memory 104, an operation button 108, a power switch 109, a bus line 110, a network I/F 111, a camera 112, an image pickup element I/F 113, a microphone 114, A speaker 115, a sound input/output I/F 116, a display I/F 117, a sensor controller 118, a short-range communication circuit 119, and an antenna 119a of the short-range communication circuit 119 are provided in a cabinet 11.

The CPU (Central Processing Unit) 101 controls the overall operation of the information processor 1. The ROM (Read Only Memory) 102 stores a program used for driving the CPU 101, such as an IPL (Initial Program Loader). In addition, the ROM 102 may store the programs of the processes (A1) to (A3) described above.

A RAM (Random Access Memory) 103 is used as a work area of the CPU 101. The flash memory 104 stores various data such as the game program, the communication program, the image data, and the sound data having the processes (A1) to (A3) etc. of the present invention described above. The operation button 108 is a button that is operated when the information processor 1 is initially set. The power switch 109 is a switch for switching ON/OFF of the power of the information processor 1.

The network I/F (Interface) 111 is interface for performing a data communication by utilizing a communication network such as the Internet. The camera 112 is a kind of built-in type image pickup unit that captures an image of a subject under the control of the CPU 101 to obtain image data. The image pickup element I/F 113 is a circuit that controls driving of the camera 112. The microphone 114 is a kind of built-in type sound collecting unit for inputting a sound. The sound input/output I/F 116 is a circuit for processing input and output of sound signals between the microphone 114 and the speaker 115 under the control of the CPU 101. The display I/F 117 is a circuit that transmits image data to the display 120 under the control of the CPU 101. The display 120 is provided on the front surface of the cabinet 11. The sensor controller 118 is a circuit that receives an input from the touch panel 5 provided on the display 120. The short-range communication circuit 119 is a communication circuit such as an NFC (Near Field Communication) (registered trademark), a Bluetooth (registered trademark), or the like. The bus line 110 is an address bus, a data bus, or the like for electrically connecting each component such as the CPU 101.

(Information Processor 1: Specific Example: Slot Game)

The information processor 1 having the above-described electric configuration is a game machine that runs a slot game.

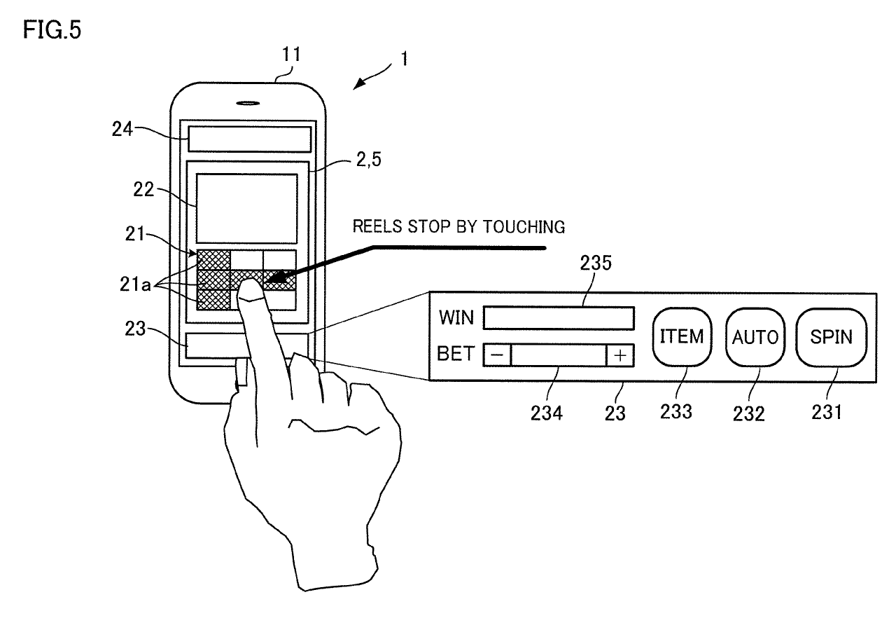

As shown in FIG. 5, a slot game screen is displayed on the display 2 of the information processor 1 which is a game machine that runs a slot game. The slot game screen includes a game area 21a in which a plurality of symbol display areas are displayed in a configuration of a plurality of rows and a plurality of columns, an effect area 22 displaying a dynamic image or a still image such as a game character with matching to the slot game, an operation area 23 operated by the player for the progress of the game, and a game information display area 24 for displaying game contents and game information. The operation area 23 includes a spin button 231, an AUTO button 232, an ITEM button 233, a BET button 234, and a WIN display portion 235 as images.

The touch panel 5 that transmits the game screen is provided on the entire surface of the display 2. The touch panel 5 makes it possible to detect the coordinate of the site touched by the player's finger or the like. Thus, for example, by pressing the image of the spin button 231, one slot game (unit game) can be executed. In addition, by pressing the image of the AUTO button 232, the slot game can be continuously performed.

(Information Processor 1: Specific Example: Slot Game: Definition)

The “base game” of the slot game of the present embodiment is a game in which a plurality of symbols are stopped and displayed (arranged) after variation in the game area 21, and includes a normal game. In addition, a state in which symbols are stopped and displayed after variation in the game area 21 is referred to “rearrangement”. The slot game executes a free game as a bonus game with one or more number of game play. The slot game may have a process of executing a free game in which a bonus payout corresponding to the symbols after rearrangement is given under a condition that the payout rate is larger than that of the normal game.

A “gaming value” given when obtaining a bonus according to the game result is a coin, a bill or an electronic valuable information equivalent thereto. The gaming value in the present invention is not particularly limited, and it may be a gaming medium such as a medal, a token, an electronic money, a ticket, and the like. The ticket is not particularly limited, and may be, for example, a bar-coded ticket or the like. Further, the “gaming value” may also be a game point which does not have an valuable information.

The “free game” is a game that is capable of executing at least bets of gaming value than the normal game. The “capable of executing at least bets of gaming value” includes the case where the bet is “0”. Therefore, the “free game” may be a game which is executed without setting the bet of gaming value as a condition and pays the amount of gaming value corresponding to the rearranged symbols. In other words, the “free game” may be a game which is started without a precondition of consumption of gaming value. Correspondingly, the “normal game” may be a game which is executed with setting the bet of gaming value as a condition and pays the amount of gaming value corresponding to the rearranged symbols. In other words, the “normal game” may be a game which is started with a precondition of consumption of gaming value.

The “unit game” is a series of actions from the start of receiving a bet to a state where a bonus can be established. That is, the unit game is a state in which a bet time for receiving a bet, a game time for rearranging the stopped symbols, and a payout time of the payout process for giving the payout are each included for once.

The “rearrangement” is a state in which symbols are stopped and displayed after variation in the game area 21. In other word, the “rearrangement” means a state in which the symbols are rearranged after the arrangement of the symbols are dismissed. The “arrangement” means a state in which the symbols may be confirmed by a visual contact with respect to the player outside.

(Information Processor 1: Specific Example: Function Block)

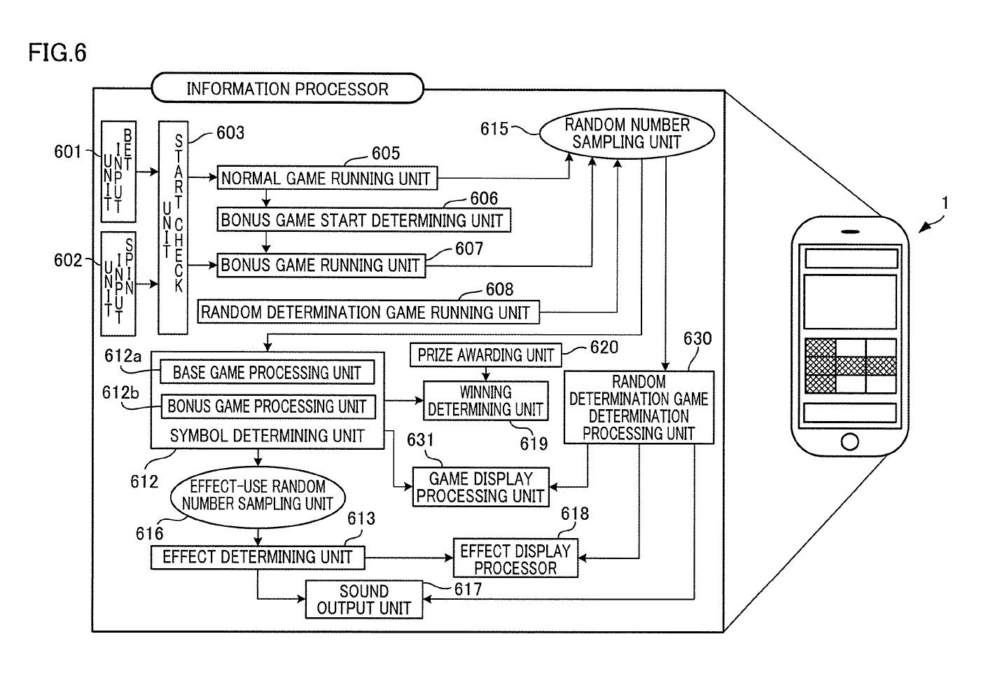

As shown in FIG. 6, the information processor 1 that is a slot machine which runs the slot game has the following functions. More specifically, the information processor 1 has a BET input unit 601 and a spin input unit 602. The BET input unit 601 and the spin input unit 602 are a type of input device. The BET input unit 601 has a function of accepting a bet by the operation of a player. The spin input unit 602 has a function of accepting the start of the game by the operation of the player, that is, the start operation.

In addition, the information processor 1 includes a start check unit 603, a normal game running unit 605, a bonus game start determining unit 606, a bonus game running unit 607, a random determination game running unit 608, a random number sampling unit 615, a symbol determining unit 612, an effect-use random number sampling unit 616, an effect determining unit 613, a sound output unit 617, an effect display processing unit 618, a winning determining unit 619, a prize awarding unit 620, a random determination game determination processing unit 630, and a game display processing unit 631.

The normal game running unit 605 has a function of running a normal game which is a base game on the condition of the operation of the BET input unit 601. The bonus game start determining unit 606 determines whether or not to run a bonus game based on a combination of symbols rearranged in the normal game. That is, when the bonus symbols are rearranged, the bonus game start determining unit 606 determines that the bonus game has been won and transitions the process to the bonus game running unit 607 so as to execute the bonus game from the next unit game. The random determination game running unit 608 has a function of drawing a plurality of prizes including a bonus game and is executed after execution of the bonus game running unit 607 so that the bonus game can be repeatedly executed.

The symbol determining unit 612 includes a base game processing unit 612a and a bonus game processing unit 612b. The symbol determining unit 612 including these processing units 612a and 612b has a function of determining symbols to be rearranged using the random number from the random number sampling unit 615, a function of rearranging the determined symbols on the display 11, a function of outputting the symbol rearrangement information to the winning determining unit 619, and a function of outputting the effect instruction signal to the effect-use random number sampling unit 616 based on a combination of rearrangement of the symbols.

The effect-use random number sampling unit 616 has a function of extracting the effect-use random number when receiving the effect instruction signal from the symbol determining unit 612, and a function of outputting the effect-use random number to the effect determining unit 613. The effect determining unit 613 has a function of determining effect content using the effect-use random number, a function of outputting the image information of the determined effect content to the effect display processing unit 618, and a function of outputting the sound/light emission information of the determined effect content to the sound output unit 617.

The winning determining unit 619 has a function of determining whether the winning has been made based on the combination of symbols when the symbol rearrangement information is obtained, a function of calculating the payout amount based on the winning combination when it is determined that the winning has been made, and a function of outputting a payout signal based on the payout amount to the prize awarding unit 620. The prize awarding unit 620 has a function of paying out the game value to the player.

The random determination game determination processing unit 630 has a function of running a random determination game of awarding prizes including the bonus game based on a random number obtained by random number determination after the end of the bonus game, and outputs effect data of the random determination game to the game display processing unit 631, the effect display processing unit 618, and the sound output unit 617.

(Information Processor 1: Specific Example: Login)

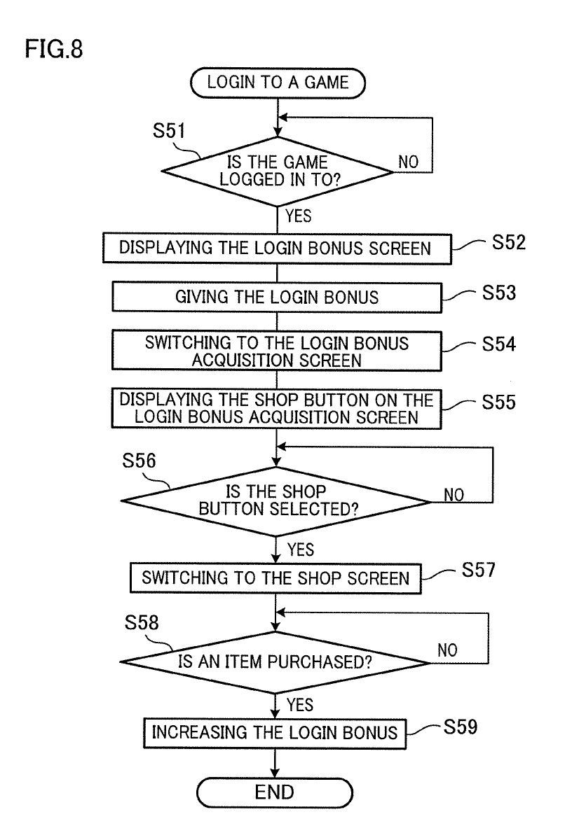

FIG. 8 is a flowchart showing the flow when the game player logs in to the game. In step S51, the game controller 10 determines whether or not the game player has logged in to the game. If logged in, the process proceeds to step S52, and if it is not logged in, it repeats. When the game player touches the game icon 12 shown in FIG. 2A, the user logs in to the game and the display 2 is switched to the game screen. Further, by logging in to the game, the terminal controller 4 can receive a signal indicating that the login is authenticated transmitted from the server 7, and pop up the shop button (payment image icon) 11.

In step S52, the game controller 10 displays a login bonus display screen below the game screen of the display 2 (see FIG. 2B). In step S53, the game controller 10 gives the reward (predetermined benefit) presented on the login bonus display screen to the game player. When the game player acquires the reward by the login bonus, the lower side of the display 2 is switched from the login bonus display screen to the login bonus acquisition screen (see FIG. 2C) in step S54.

In step S55, the terminal controller 4 automatically pops up and displays the shop button 11 on the login bonus acquisition screen. Simultaneously with the display of the shop button 11 pop-up on the acquisition login bonus acquisition screen, the possessed number of items stored in association with the authentication information of the game player is displayed on the display 2. Therefore, it is possible to easily guide the shop screen through the shop icon 11 while allowing the game player to recognize the possessed number of the items currently possessed.

In step S56, the game controller 10 determines whether or not the game player has selected the shop button 11. If the shop button 11 is selected, the process proceeds to step S57, and if it is not selected, the process is repeated. In step S57, the game controller 10 transitions the display 2 from the login bonus acquisition screen to the shop screen (see FIG. 2D) based on the predetermined process of the payment attraction program. In step S58, the game controller 10 determines whether or not the game player purchased the items. If so, the process proceeds to step S59, and if not, the process is repeated. In step S59, the game controller 10 increases the login bonus already acquired by the game player. When the game player purchases an item in the shop, since the acquired login bonus increases, it is possible to urge the game player to purchase items, prompting the payment for purchasing the items.

In the embodiment, the predetermined benefit means a login bonus, and the game player increases the login bonus by purchasing items on the shop screen, but the present invention is not limited thereto. For example, at the timing when the game player acquires a coin during the progress of the game, an icon prompting to transition to the shop screen may be displayed on the display 2 and the game player may be guided to the shop screen. At this time, the predetermined benefit refers to the coin acquired by the game player during the progress of the game, but of course it is not limited to coins.

Further, in the embodiment, the shop screen is adopted as the payment screen, but it is not particularly limited as long as it is a screen on which the game player can selectively purchase items.

(Information Processor 1: Specific Example: Game Content)

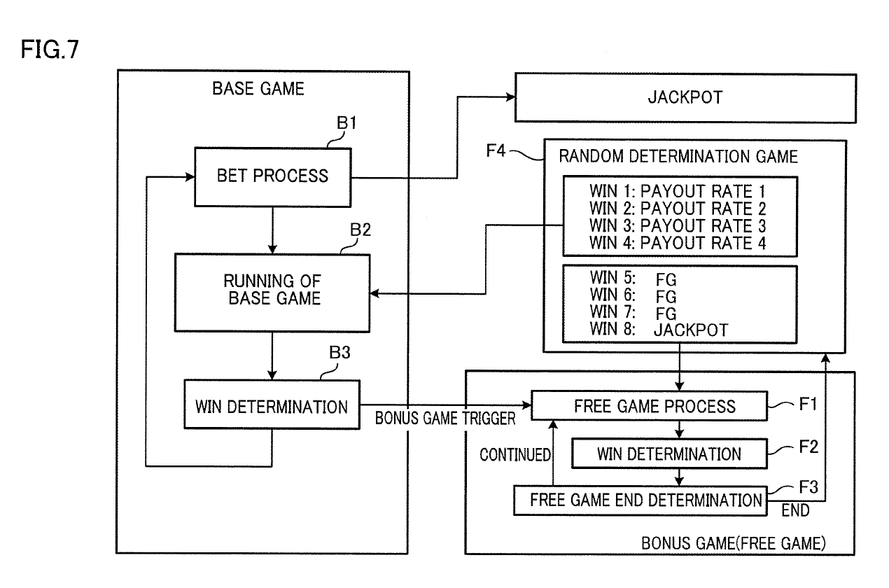

FIG. 7 is a diagram showing a state transition in the information processor 1 which is a game apparatus. Specifically, it shows transition among the base game mode, the bonus game mode (free game), and the random determination game mode. The base game mode is a game state during the normal game, and the bonus game mode corresponds to the game state during the free game.

The information processor 1 has three game modes: a base game mode, a bonus game mode, and a random determination game mode. In the information processor 1, the unit game is executed with the base game mode as a main mode, and when the bonus trigger condition is satisfied in the base game mode, the information processor 1 shifts to the bonus game mode. For example, the trigger of the bonus game is a condition that three or more bonus symbols are repeated (rearranged) from the first reel continuously. In addition, the trigger of the bonus game may be other conditions.

(Information Processor 1: Specific Example: Game Content: Base Game Mode)

Explaining concretely the base game mode, in the game area 21 displayed on the display 11 of FIG. 5, symbols for the slot game of a video reel can be rearranged in three rows and three columns. In a bet process (B1), the bet amount is selected by the player. For example, selection of 1, 2, 3, 5, 10, etc. for the bet amount is enabled by the operation of the bet button 234. Then, the resource obtained through accumulating a part of these bet amount is taken as a jackpot.

Next, when symbols are rearranged by variable display (scroll movement) and stop display (scroll stop) of the video reels, presence or absence of winning is determined. Then, the win determination is performed based on the rearrangement pattern of the rearranged symbols (B3). For example, if bonus symbols are continuous from the first array area (first reel) to the third array area (third reel), the winning of a bonus game trigger is established. In addition, if the bonus symbols and the wild symbol determined as a substitute for the bonus symbols are continuous, the winning of the bonus game trigger is established.

(Information Processor 1: Specific Example: Game Content: Bonus Game Mode)

In the base game mode, when the trigger condition of the bonus game is satisfied, the mode is shifted to the bonus game mode, and first the free game process is executed (F1).

In the free game process, a reel strip for the free game to be used during the free game is determined, and a predetermined number of times of execution of the free game is set. In addition, the reel strip and the number of times of execution of the free game for the free game may be set from a random determination among a plurality of selections.

When the free game is executed, a win determination is performed (F2). In addition, the win determination may be the same as the win determination of the base game (B3). For example, when three or more bonus symbols appear consecutively from the first reel, the re-trigger condition of the bonus game (free game) is satisfied.

Thereafter, the end of the free game is determined (F3), and only if the free game has not ended (continued), the remaining free game is executed in F1. On the other hand, when the free game ends, the game shifts to a random determination game (F4).

(Information Processor 1: Specific Example: Game Content: Random Determination Game Mode)

The random determination game is performed by displaying a random determination game screen on the display 2. The random determination game screen has an effect comment screen such as “chance to obtain a large amount of coins” and a first winning portion to an eighth winning portion which are eight winning display areas. In the case of winning in the first winning portion to the fourth winning portion, the base game will be shifted to.

Each winning portion is corresponding to an award including a bonus game. Specifically, the first winning portion is corresponding to an award that enables a payout of a payout rate that is one times the total payout of the bonus game (multiple free games) performed before the random determination game. The second winning portion is corresponding to an award that enables a payout of a payout ratio doubling the above-mentioned total payout. The third winning portion is corresponding to an award that enables a payout of a payout ratio three times the above-mentioned total payout. The fourth winning portion is corresponding to an award that enables a payout of a payout ratio four times the above-mentioned total payout. The fifth winning portion is corresponding to an award for the bonus game consisting of free game of five games. The sixth winning portion is corresponding to an award for the bonus game consisting of free game of ten games. The seventh winning portion is corresponding to an award for the bonus game consisting of free game of fifteen games. The eighth winning portion is corresponding to an award of jackpot. Here, the jackpot is a payout which is larger than the payout obtained by the stop symbol array in the base game in general, and one in which a part of the payout is accumulated for each bet is an award (progressive jackpot).

(Information Processor 1: Specific Example: Game Content: Slot Game Process)

Next, program of the slot game executed by the CPU 101 of the information processor 1 will be described.

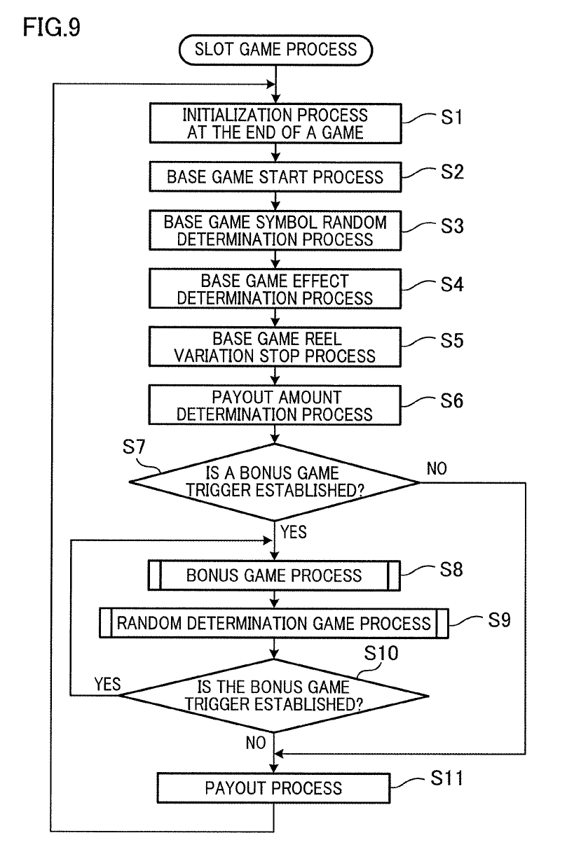

As shown in FIG. 9, an initializing process at the end of each play of the game is executed (S1). For example, this process clears data in a working area of the RAM 103, which becomes unnecessary at the end of each play of game, e.g., the bet amount and symbols selected by random determination. After a base game start process (S2), a base symbol random determination process is executed (S3). In this process, to-be-stopped symbols are randomly selected and determined based on a random number by using a random determination table.

Then a base game effect determination process is executed (S4). The CPU 101 samples an effect-use random number and randomly determines any of a plurality of predetermined effect contents, and executes the determined effect content at the determined timing. For example, an effect image is displayed in an effect area 22 of the display 120, and sound is output by the speaker 115.

Then a base game reel variation stop process is executed (S5). In this process, the scroll of the symbol columns in the symbol display area 21a starts, and the to-be-stopped symbols determined in the base game symbol random determination process are stopped at predetermined positions.

Then a payout amount determination process is executed (S6). In the base game, a payout amount is determined in accordance with a combination of symbols and based on a payout table, and the determined payout amount is stored in a payout amount storage area of the RAM 103. When the bonus game trigger is established, a payout amount is determined in accordance with a combination of bonus symbols, based on a rule different from the rule in the base game.

Then whether the bonus game trigger has been established is determined (S7). When the bonus game trigger has been established (YES in S7), a bonus game process is executed (S8). Then a later-described random determination game process is executed (S9) and whether the bonus game trigger has been established is determined in the random determination game process (S10). When the bonus game trigger has been established (YES in S10), the bonus game process in S8 is executed again.

In the meanwhile, if the bonus game trigger has not been established in S7 or S10 (NO in S7 or S10), a payout process is executed (S11). The CPU 101 adds a value stored in the payout amount storage area to a value stored in a credit amount storage area (credit counter) provided in the RAM 103. Then the steps are executed again from S1.

(Information Processor 1: Specific Example: Game Content: Bonus Game Process)

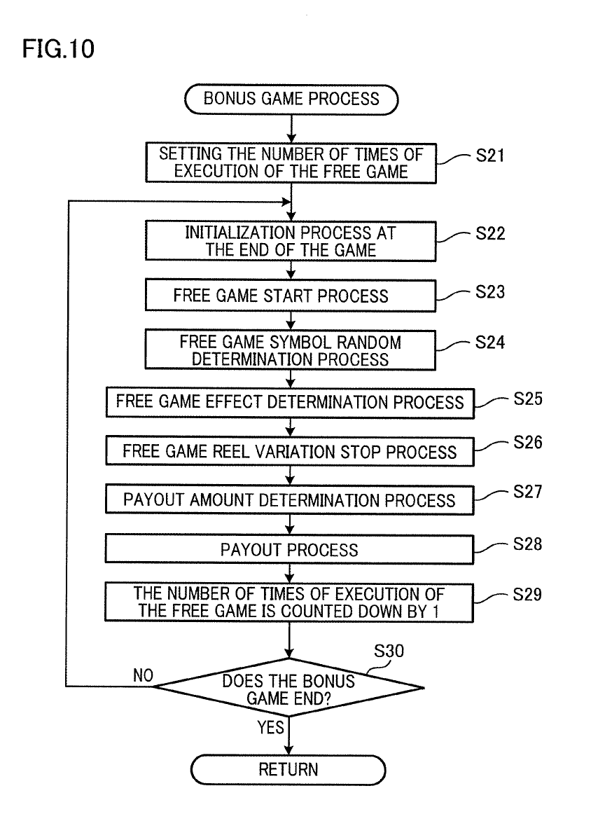

The following describes a bonus game process with reference to FIG. 10. The bonus game process is a process executed when the bonus game trigger is established.

To begin with, the number of times of execution of the free game is set (S21). For example, the number of times of execution of the free game is set at 5. Then an initializing process at the end of each play of the game is executed (S22). For example, this process clears data in a working area of the RAM 103, which becomes unnecessary at the end of each play of game, e.g., the symbols selected by random determination. It is noted that the bet amount in the bonus game is identical with the bet amount in the base game immediately before the shift to the bonus game.

Thereafter, in the same manner as in the base game, a free game start process (S23), a symbol random determination process (S24), and a free game effect determination process (S25) are executed. In the free game, a free game symbol random determination table different from the symbol random determination table in the base game is used. In the free game symbol random determination process, when a Huge Chili flag is set at 1, random determination is executed such that a Huge Chili symbol is to be rearranged.

Thereafter, a free game reel variation stop process (S26) is executed to vary and stop the reels. Thereafter, a payout amount determination process (S27) and a payout process (S28) are serially executed, and then the number of times of execution of the free game is counted down by 1. Then whether the bonus game has ended is determined (S30). When the number of times of execution of the free game is not 0 (NO in S30), the steps are executed again from S22 as it is determined that the bonus game has not ended. In the meanwhile, when the number of times of execution of the free game is 0 (YES in S30), it is determined that the bonus game has ended. The process is then terminated and the processing routine shown in FIG. 9 is resumed.

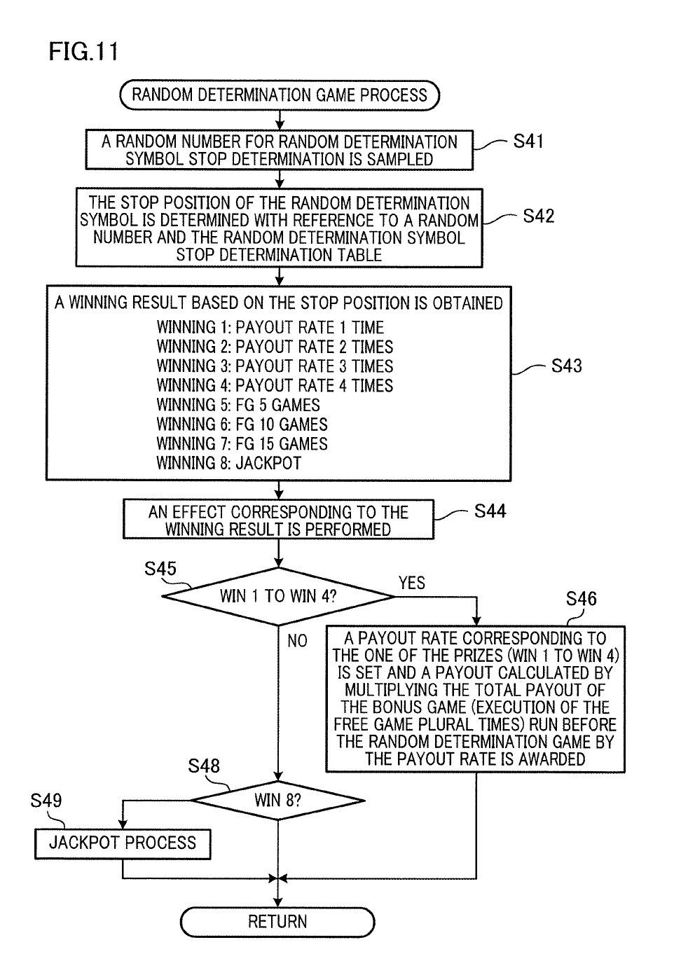

(Information Processor 1: Specific Example: Game Content: Random Determination Game Process) The following describes a random determination game process with reference to FIG. 11. The random determination game process is a process executed when the bonus game ends.

To begin with, a random number for random determination symbol stop determination is sampled (S41). Thereafter, the stop position of the random determination symbol is determined with reference to a random number and the random determination symbol stop determination table (S42).

In the present embodiment, the symbol stops at one of the eight winning portions 2521 to 2528. Thereafter, a winning result based on the stop position is obtained (S43). To put it differently, a prize corresponding to one of the winning portions 2521 to 2528 (i.e., one of win 1 to win 8) is obtained. Then an effect corresponding to the winning result is performed (S44).

Subsequently, whether the winning result is one of prizes (win 1 to win 4) is determined (S45). When the result is one of the prizes (win 1 to win 4) (YES in S45), a payout rate corresponding to the one of the prizes (win 1 to win 4) is set and a payout calculated by multiplying the total payout of the bonus game (execution of the free game plural times) run before the random determination game by the payout rate is awarded (S46), and then the routine ends.

On the other hand, if the winning result is not the prize (win 1) to the prize (win 4) (NO in S45), it is determined whether or not the winning result is a prize (win 8) (S48). When the winning result is a prize (win 8) (YES in S48), a jackpot process is executed, a jackpot payout is performed, and effect for jackpot is performed (S49). Then, this routine is ended. When the winning result is not a prize (win 8) (NO in S48), the bonus game trigger is set so that the bonus game is repeated (S50), and this routine is ended.

Although the embodiment of the present invention has been described above, it is merely a specific example, and the present invention is not particularly limited, and the specific configuration of each means and the like can be appropriately designed and changed. In addition, the effects described in the embodiments of the present invention are merely a list of the most preferable effects produced by the present invention, and the effects of the present invention are not limited to those described in the embodiments of the present invention.

What is claimed is:

1. An information processor, comprising:
an input device that performs an operation related to a game,
a display for displaying a game screen based on the operation of the input device, and
a controller that gives a predetermined benefit after the game screen is displayed on the display, the controller executing:
a process of displaying an icon prompting transition to a payment screen for paying on the display after the game screen is displayed,
a process of transitioning to the payment screen when the icon is selected by the input device, and
a process of increasing the predetermined benefit when paying on the payment screen.

2. The information processor according to claim 1, wherein authentication information for each game player is stored in a storage device connected to the controller, and in association with the authentication information, the possessed number of the items that can be purchased via a shop screen as the payment screen is stored, and the possessed number of the items stored in association with the authentication information of the game player is displayed simultaneously with the display of the icon popped up after the game screen is displayed.

3. The information processor according to claim 1, wherein:
the game screen is displayed after logging in to the input device,
the predetermined benefit is a login bonus given with the logging,
the login bonus increases when paying on the shop screen as the payment screen.

4. A non-temporary recording medium storing a game program of an information processor, the information processor comprising:
an input device that performs an operation related to a game,
a display for displaying a game screen based on the operation of the input device, and
a controller that gives a predetermined benefit after the game screen is displayed on the display, the controller executing:
a process of displaying an icon prompting transition to a payment screen for paying on the display after the game screen is displayed,
a process of transitioning to the payment screen when the icon is selected by the input device, and
a process of increasing the predetermined benefit when paying on the payment screen.

5. A game control method of an information processor,
the information processor comprising:
an input device that performs an operation related to a game,
a display for displaying a game screen based on the operation of the input device, and
a controller that gives a predetermined benefit after the game screen is displayed on the display, the method comprising the steps of:
displaying an icon prompting transition to a payment screen for paying on the display after the game screen is displayed,
transitioning to the payment screen when the icon is selected by the input device, and increasing the predetermined benefit when paying on the payment screen.
